(19) United States
(12) Patent Application Publication
(10) Pub. No.: US 2005/0126235 A1
(43) Pub. Date: Jun. 16, 2005

(54) Method and kit for securing an upwardly acting cargo container door

(76) Inventor: J.E. Melchiori, Loxahatchee, FL (US)

Correspondence Address: MCHALE & SLAVIN, P.A., 2855 PGA BLVD, PALM BEACH GARDENS, FL, 33410, US

(21) Appl. No.: 10/737,246

(22) Filed: Dec. 15, 2003

(51) Int. Cl. E05B 13/00

(52) U.S. Cl. 70/210

(57) ABSTRACT

The present invention provides a method and kit for assembling a high security latch and lock assembly for an upwardly acting cargo container door. More specifically, the instant invention provides a secure and transferable lock assembly engagable with a preexisting cargo container latch assembly for holding the latch handle in the latched position.

### FIELD OF THE INVENTION

The present invention relates to a method and kit for modifying a pre-existing cargo container latch assembly for an upwardly acting door to accept a high security sliding bolt lock.

### BACKGROUND OF THE INVENTION

Cargo carrying vehicles, e.g. box trucks, tractor trailers and the like, that traverse public roadways are constantly subjected to the danger of cargo theft. Most cargo thefts occur when the truck is parked, such as at a truck stop, rest area or café. However, thieves are constantly devising new methods of stealing cargo, and thefts may now occur while the vehicle is in motion. These thefts result in losses to the vehicle owner, the insurance carrier, and indirectly to the public at large.

One of the most common door and latch combinations includes an upwardly acting door having a pivoting latch as is taught in U.S. Pat. No. 3,642,314.

Persons familiar with the manufacture, installation and maintenance of doors, particularly upward acting tractor trailer type doors, have long been aware that the latch structures of such doors are subject to unusually rough treatment, even under substantially normal operating conditions. Container doors and their lock structures are constantly exposed to the weather and are often strained by the loads carried in the container or battered by external obstructions. In addition the latches and doors are often the subject of attempted unauthorized entry.

In order to prevent unauthorized entry into the cargo area of a van or truck, the trucking industry has in the past employed numerous varieties of doors and latching mechanisms. Generally, the door and latch structure is provided with some type of locking mechanism, typically a padlock having a U-shaped shackle, which releasably holds the door latch handle in the engaged position.

For example, U.S. Pat. No. 3,740,978, teaches a latch and lock assembly for use on an overhead type cargo door. The assembly includes a catch pin mounted to the bed portion of the truck or similar vehicle and a latch mechanism mounted upon the lower portion of the truck or van door. The latch mechanism includes an elongated handle pivotally mounted upon the lower portion of the door. The handle includes a C-shaped portion on its distal end which cooperates with the locking assembly. The lock assembly includes a bracket that is mounted to the lower portion of the door. The bracket is constructed having a generally rectangular shape with one closed end wall. Attached to the closed end wall is a pair of steel rods which take the place of a standard U-shaped padlock shackle. The padlock body is attached to the steel rods in a conventional manner to allow limited movement of the body. In operation the latch handle is rotated to latch the door and the lower end of the C-shaped portion of the handle passes between the lock shackles. The lock body can thereafter be pushed inwardly to engage the lock thereby locking the door in place. The lock body is releasable by a key; after release the lever can be moved into a release position and the door opened.

U.S. Pat. No. 5,737,946 teaches a semi-trailer anti-theft device. The device includes a shield which extends over and substantially encloses both the cargo door latch handle and the padlock. The shield includes an elongated front panel which extends across the latch handle. At one end of the front panel on the rear side is a forked member which can be inserted around the pivot pin of the latch handle to allow the shield to be swung into alignment with the latch handle. The opposite end of the shield is constructed as a padlock guard having a rearwardly extending flange which extends over the top of the padlock and a lock plate covering the face of the padlock. A locking web also extends rearwardly from the front panel below the flange. The locking web includes an aperture arranged to allow the padlock shackle to pass through. In operation, the forked end of the shield is slid over the pin of a latched door lever and rotated downwardly until the padlock can be slid through the handle and the locking web.

U.S. Pat. No. 6,058,745, teaches a padlock cover assembly for covering U-shaped shackle padlocks on latching and locking doors. The elongated boxlike cover is secured to one of doors via a pivoting hinge which allows the cover to pivot along two axis. A padlock mounting bracket is secured to the second door. In operation, an unlocked padlock is placed through the mounting bracket. The cover is rotated over the unlocked padlock and pushed upward to engage the padlock. As the padlock is engaged a pawl formed on the back of the cover is advanced between the padlock shackle and the upper surface of the padlock body. As the cover is pivoted to advance the padlock to a closed position, the pawl extends into interlocking engagement with the shackle of the padlock. To unlock the padlock, the cover is provided with an aperture in its lower portion for access with a key.

The U-shaped shackle padlocks utilized in the prior art are easily cut with readily available bolt cutters or frozen and broken with a compressed gas source, such as a fire extinguisher. In addition, because the padlocks are not attached to the trailer door they are often misappropriated or lost. Accordingly, the cost of padlock replacement often reaches thousands of dollars per year for an average size trucking company.

The prior art has also suggested the use of latching mechanisms constructed specifically for attachment to the container door. For example, U.S. Pat. No. 3,893,722, discloses a latch and lock assembly for use on an overhead type cargo door. The assembly includes a catch pin mounted to the bed portion of the truck or similar vehicle and a latch mechanism mounted upon the lower portion of the truck or van door. The latch mechanism includes an elongated handle pivotally mounted upon the lower portion of the door. The handle includes a C-shaped portion on its distal end which cooperates with the locking mechanism. The locking assembly is mounted to the lower portion of the door within a box type bracket. Within the bracket is a spring loaded lever and a keyed cylinder. In operation the latch handle is rotated to latch the door and the C-shaped portion of the handle engages the spring loaded lever to lock the door in place. To release the lever a key is used to rotate the spring loaded lever into a disengaged position, allowing the handle to be rotated.

Latching mechanisms such as the one described above often become inoperable due to the rough treatment which truck doors receive and, as a result of the one piece construction they require replacement of the entire latch mechanism for repair. In addition, it is often desirable for a driver to transfer a lock from one cargo container to another to minimize the number of persons that have access to keys for a locking mechanism, an impossible task for a one piece lock and latch mechanism. The one piece devices become cumbersome, requiring transference of the latch keys with each transfer of the container.

Accordingly, what is lacking in the prior art is a cost effective locking assembly for use with an upwardly acting cargo container door. The locking assembly should achieve objectives such as reliable security and lock tranferability. The locking assembly should include packaging flexibility for installation on various trailer door configurations with minimal modification of the original latching mechanism. The lock should be capable of withstanding the harsh environment of the trucking industry and should allow for easy replacement and repair.

### SUMMARY OF THE INVENTION

The present invention provides a method and kit for assembling a high security latch and lock assembly for an upwardly acting cargo container door. More specifically, the instant invention provides a secure and transferable lock assembly engagable with a preexisting cargo container latch assembly for holding the latch handle in the latched position.

Cargo containers for truck use generally include a bed portion, a left side wall, a right side wall, a front wall, a roof panel and an upward acting door. The upward acting door is generally comprised of a plurality of horizontally hinged sections which are disposed in a substantially vertical plane when the door is closed, and in a substantially horizontal plane near the roof panel when the door is open. Pivotally mounted upon a lower portion of the upward acting cargo container door is a latch. The latch typically includes a backing plate secured to the rear surface adjacent a lower portion of the door. The backing plate includes an axle secured thereto and a hub rotatably supported on the axle. An elongated handle and an arcuate catch are secured or integrally formed to the hub with the handle extending substantially radially from the hub. The distal end of the handle includes an integrally formed depending tab having an aperture drilled generally parallel to the handle. The arcuate catch extends from the hub and is adapted to cooperate with a catch pin mounted to the bed portion of the cargo container. The latch is manually rotatable between a latched position and an unlatched position. A latched keeper includes an integral hub pivotally mounted on a pivot pin secured to the backing plate; the latched keeper having a downwardly and frontwardly projecting flange integrally formed on its hub, the flange having an opening which aligns with the aperture in the depending tab of the handle when the latch is in the latched position, for receiving a conventional U-shaped shackle padlock.

The instant invention modifies the latch mechanism described above to include a sliding bolt lock by removing the latched keeper from the backing plate and positioning a sliding bolt lock adjacent to the distal end of the handle when the handle is in a latched position so that the sliding bolt portion of the sliding bolt lock engages the handle to prevent rotation thereof in a locked position. The sliding bolt lock can then be secured to the lower portion of the door utilizing a plurality of L-shaped tabs secured to the body portion of the sliding bolt lock. The L-shaped tabs each include a vertical portion and a horizontal portion, wherein the vertical portion is secured to the body portion of the sliding bolt lock and the horizontal portion includes at least one aperture therethrough. The tabs may be attached to the backing plate with standard fasteners or weldments.

In an alternative embodiment the sliding bolt lock may be supplied with a casing for releasably securing the sliding bolt lock adjacent to the end portion of the handle. The casing would include an inner surface and an outer surface with the inner surface having a conjugate shape to the body portion of the sliding bolt lock. The casing also includes a small aperture which is adapted to cooperate with a spring pin built into the body of the lock. Depressing the spring pin while the sliding bolt is in an unlocked position allows the lock to be inserted or removed from the casing. A plurality of L-shaped tabs are secured to the outer surface of the casing for attachment to the lower portion of the door. Each of the L-shaped tabs include a vertical portion and a horizontal portion, wherein the vertical portion is secured or integrally formed onto the outer surface of the casing and the horizontal portion includes at least one aperture therethrough. The tabs may be attached to the backing plate with standard fasteners or weldments.

Accordingly, it is an objective of the present invention to provide a kit for improving the security provided by a latch and lock structure for an upwardly acting cargo container door.

Another objective of the present invention is to provide a method for improving the security provided by a latch and lock structure for an upwardly acting cargo container door.

An additional objective of the present invention is to provide a lock mechanism for an upwardly acting cargo container door which prevents pilferage of the lock mechanism and minimizes the possibility for unauthorized opening of the lock.

Yet another objective of the present invention is to provide a lock kit for an upwardly acting cargo container door that allows lock portability while minimizing the possibility of lock misappropriation and/or loss.

Other objects and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a front view partially in section illustrating a prior art latch mechanism for an upwardly acting cargo container door;

FIG. 2 is a front view partially in section illustrating one embodiment of the modified latch mechanism of the present invention;

FIG. 3 is a top view partially in section illustrating a top view of the modified latch mechanism of the present invention; FIG. 4 is a section view along lines 1-1 of FIG. 2 illustrating the cooperative engagement between the handle and the sliding bolt lock of the present invention;

FIG. 5 is a front view partially in section and partially exploded illustrating an alternative embodiment of the present invention FIG. 6 is an end view of the alternative embodiment illustrated in FIG. 5.

### DETAILED DESCRIPTION OF THE INVENTION

Although the invention is described in terms of a preferred specific embodiment, it will be readily apparent to those skilled in this art that various modifications, rearrangements and substitutions can be made without departing from the spirit of the invention. The scope of the invention is defined by the claims appended hereto.

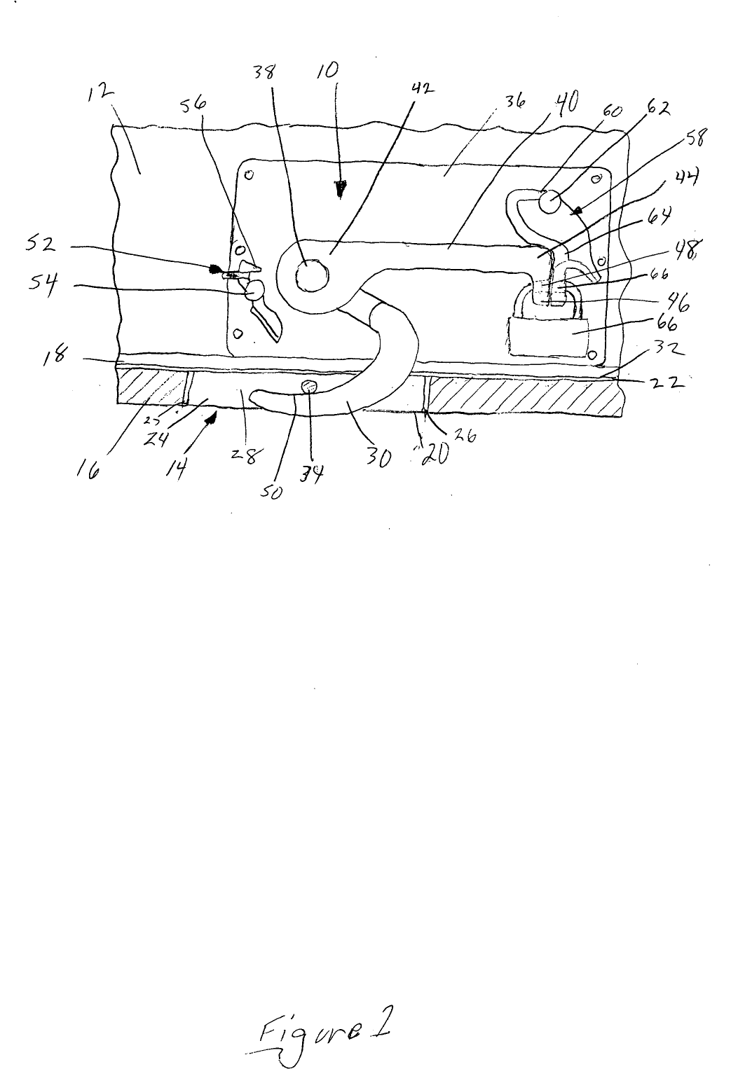

Referring to FIG. 1, the latch and door structure utilized in the instant invention is comprised of a latch assembly 10 mounted on the lower portion of an upwardly acting door 12 for engagement with a catch pin assembly 14 that is mounted in the bed 16 of a conventional cargo container for a truck or van. The door 12 is generally comprised of a plurality of horizontally hinged sections which are disposed in a substantially vertical plane, when the door 12 is closed, and in a substantially horizontal plane near the roof of the van when the door is open. A resiliently flexible weather seal 18 is mounted on the lower edge of the door 12 and is engageable with the bed 16 in a conventional manner for conventional purposes.

Still referring to FIG. 1, the catch pin assembly 14 is comprised of an elongated, substantially rectangular casing 20 having a top flange 22, a pair of side walls 24 (only the back being shown) and a pair of end walls 26 and 27 and a catch pin 34. The side walls and the end walls define a catch chamber 28 which preferably opens upward to receive the latch 30 and downwardly for drainage.

The top flange 22 preferably extends beyond both end walls 26, 27 and the back sidewall 24 for engagement with the upper surface 32 of the bed 16 when the casing 20 is located within the opening in the bed 16. The top flange 22 may be secured to the bed 16 by welding, screws or any other conventional means. The catch pin 34 is secured to and extends between the sidewalls 24 of the casing 20 about midway between the end walls 26 and 27.

The latch assembly 10 has a backing plate 36 which is secured to the rear surface of the door 12 adjacent the lower edge thereof by conventional means such as bolts, rivets or weldment. Rigidly secured to the backing plate 36 is axle 38 defining an axis of rotation for the handle 40 and the catch 30. The handle 40 and the catch 30 are rotatably supported on axle 38 to allow pivotal movement between a latched and an unlatched position. The handle 40 extends substantially radially from hub 42. The distal end 44 of the handle includes an integrally formed depending tab 46 having an aperture 48 drilled generally parallel to the handle. Also extending from the hub 42 is an elongated arcuate hook 30 having a slightly cammed inner surface 50. An unlatched keeper 52 is pivotally mounted upon a pivot pin 54 which is rigidly mounted to the backing plate 36. The keeper 52 has a hook 56 at one end which is engageable with the hub 42 to maintain the latch means in an unlatched position.

A latched keeper 58 is substantially flat and has an integral hub 60 pivotally mounted on pivot pin 62. The pivot pin is rigidly secured to the backing plate 36. A downwardly and frontwardly projecting flange 64 is integrally formed on the hub 60. The flange has an opening 66 which aligns with aperture 48 in the depending tab 46 of handle 40 when the latch means is in a latched position, for receiving a conventional U-shaped shackle lock 66.

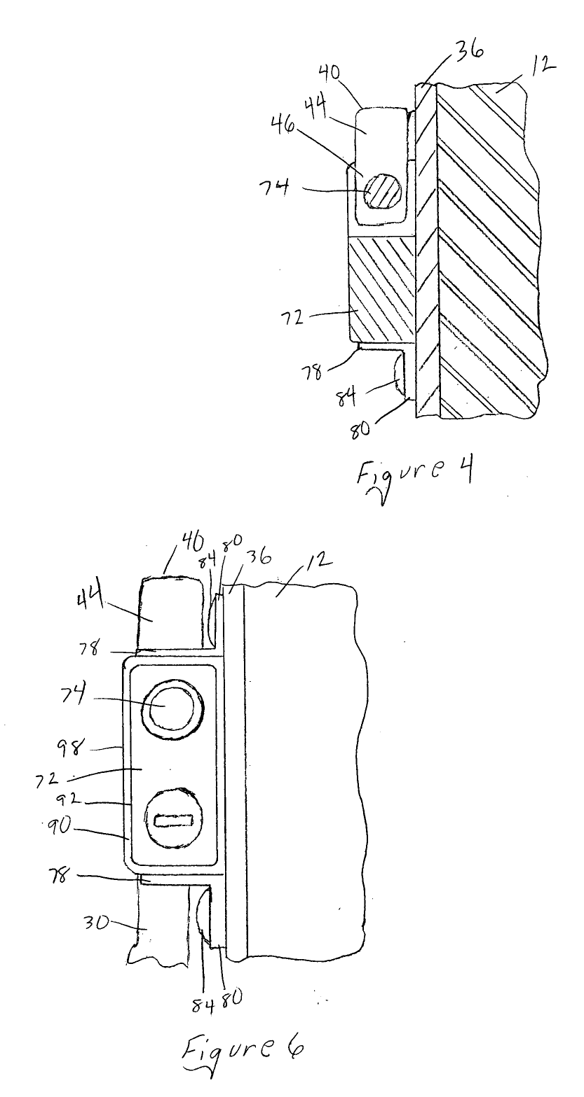

Referring to FIGS. 1 through 3, in order to alleviate the problems associated with cargo theft from cargo containers having upward acting doors, the present invention provides a method and kit for modifying the pivoting latch as set forth in FIG. 1. The method of modification generally includes removing the latched keeper 58 from the backing plate 36 by conventional means such as grinding, torch, drilling or the like. Thereafter, attaching the sliding bolt lock 70 of the instant invention kit to the backing plate 36 adjacent to the distal end portion 44 of the handle 40 when the handle is in the latched position. The sliding bolt lock 70 comprises a body portion 72 and a sliding bolt member 74, the sliding bolt member being movable between a locked position and an unlocked position. Moving the sliding bolt member between the locked and the unlocked positions engages and disengages respectively the aperture 48 in the depending tab 46 when the handle 40 is in the latched position for positively preventing movement or allowing movement respectively of the handle. The sliding bolt lock 70 may include safety features such as multi-element pin assemblies and/or cooperating computer chips in the lock cylinder and/or key. Each lock may also include an ownership identification card (not shown) that includes information required to make additional keys and/or digital information required to open the sliding bolt lock. Such sliding bolt locks are sold by Cisa Inc. of Chicago, Ill. and Mul-T-Lock Ltd of Yavne, Israel.

For securing the sliding bolt lock 70 to the backing plate 36, a plurality of L-shaped tabs 76 may be secured to the body portion 72 of the lock. Each of the L-shaped tabs 76 include a vertical portion 78 and a horizontal portion 80. The vertical portions 78 are preferably secured to the body portion 72 of the sliding bolt lock by welding; alternatively, other means well known in the art such as rivets or threaded fasteners may be utilized. In a further alternative embodiment the tabs 76 may be integrally formed to the lock body 72. The horizontal portion 80 of the tabs 76 includes at least one aperture 82 therethrough for attachment to the lower portion of the upwardly acting door 12. The horizontal portion 80 of the tabs 76 are preferably attached to the lower portion of the door via carriage type bolts 84. Alternatively, other fasteners and/or weldments well known in the art may be utilized to secure the tabs to the backing plate 36 and/or the lower portion of the door 12.

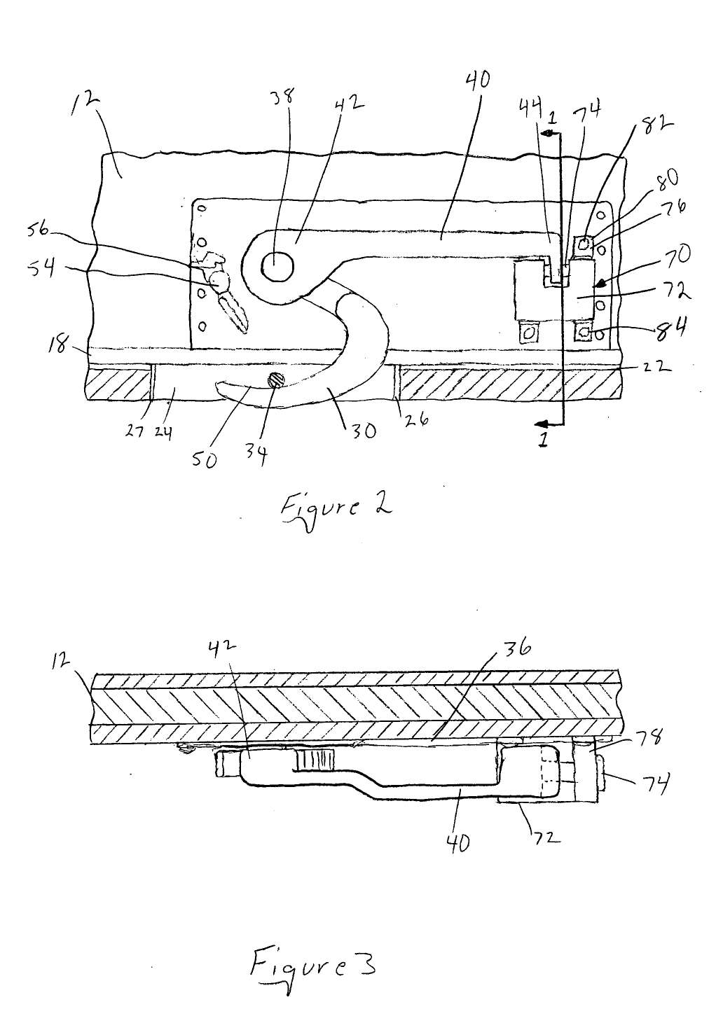

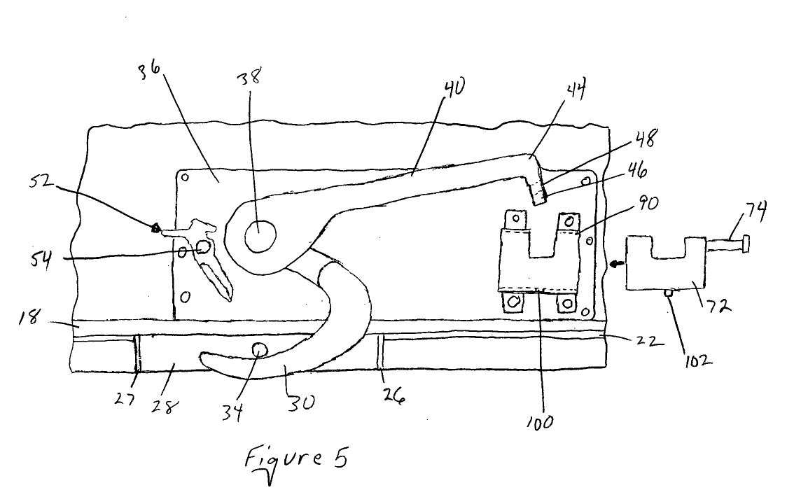

Referring to FIGS. 5 and 6, an alternative embodiment the lock is assembly is provided with a lock casing 90 for releasably securing the sliding bolt lock 70 (FIG. 2) adjacent to the end portion 44 of the handle 40. The lock casing 90 includes an inner surface 92 and an outer surface 98, the inner surface 92 having a generally conjugate shape to the body portion 72 of the sliding bolt lock. The lock casing 90 includes an aperture 100, the aperture is adapted to cooperate with a spring pin 102 incorporated into the body portion 72 of the sliding bolt lock. Depressing the spring pin 102, allows the body portion 72 to be removed from the lock casing 90 when the sliding bolt 74 is in an open position, yet secures the lock body within the lock casing 90 to prevent accidental loss or misappropriation when the sliding bolt 74 is in a locked position. The outer surface 98 of the lock casing 90 includes a plurality of L-shaped tabs 76 secured thereto, the L-shaped tabs being constructed and arranged for attachment to a lower portion of the upwardly acting door 12. Preferably each of the L-shaped tabs include a vertical portion 78 and a horizontal portion 80, wherein the vertical portion 78 is preferrably secured to the outer surface 98 of the lock casing 90 via weldment and the horizontal portion 80 includes at least one aperture 82 therethrough. In further alternative embodiments, other means well known in the art such as rivets or threaded fasteners may be utilized to attach the vertical portion of the L-shaped tabs to the outer surface 98 of the lock casing 90. In a further alternative embodiment, the L-shaped tabs 76 may be integrally formed onto the lock casing 90. In the preferred embodiments the casing may be constructed of materials well known in the art which may include, but should not be limited to metals such as steel, hardened steel, armor plated steel, aluminum, titanium and the like.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A latch and lock kit for holding an upwardly acting cargo container door in a closed position with respect to a door frame, comprising:
a latch means having a catch means and a handle constructed and arranged for mounting to a lower portion of said upward acting door for rotational movement about an axis between latched and unlatched positions, said handle means having a distal end portion opening radially relative to said axis, said distal end portion having a depending tab secured thereto, said depending tab having an aperture therethrough, said aperture adapted to cooperate with a sliding bolt member;
a sliding bolt lock constructed and arranged for attachment to said upwardly acting door adjacent to said distal end portion of said handle means when said handle means is in said latched position, said sliding bolt lock having a body portion and a sliding bolt member, said sliding bolt member movable between a locked position and an unlocked position, whereby said sliding bolt member may be moved between said locked and said unlocked positions to engage and disengage respectively said aperture in said depending tab when said handle means is in said latched position for positively preventing movement or allowing movement respectively of said handle means;
wherein pivoting said latch means about said axis to a latched position prevents upward movement of said door with respect to said door frame and pivoting said latch means about said axis to a unlatched position allows upward movement of said door with respect to said door frame.

2. The latch and lock kit as disclosed in claim 1 wherein said body portion of said sliding bolt lock is constructed of metal.

3. The latch and lock kit as disclosed in claim 1 wherein said body portion of said sliding bolt lock includes a plurality of L-shaped tabs secured thereto, said L-shaped tabs constructed and arranged for attachment to said lower portion of said upwardly acting door.

4. The latch and lock kit as described in claim 3 wherein each of said plurality of said L-shaped tabs include a vertical portion and a horizontal portion, wherein said vertical portion is secured to said body portion of said sliding bolt lock and wherein said horizontal portion includes at least one aperture therethrough for attachment to said lower portion of said upwardly acting door.

5. The latch and lock kit as described in claim 1 including a lock casing for releasably securing said sliding bolt lock adjacent to said end portion of said handle means said lock casing including an inner surface and an outer surface, said inner surface having a conjugate shape to said body portion of said sliding bolt lock, said outer surface including a plurality of L-shaped tabs secured thereto, said L-shaped tabs constructed and arranged for attachment to said lower portion of said upwardly acting door.

6. The latch and lock kit as described in claim 5 wherein each of said plurality of said L-shaped tabs include a vertical portion and a horizontal portion, wherein said vertical portion is secured to said outer surface of said casing and wherein said horizontal portion includes at least one aperture therethrough.

7. The latch and lock kit as described in claim 5 wherein said lock casing is constructed of steel.

8. The latch and lock kit as described in claim 5 wherein said lock casing is constructed of hardened steel.

9. The latch and lock structure as described in claim 5 wherein said lock casing is constructed of armor plated steel.

10. The latch and lock kit as described in claim 1 including a backing plate, said backing plate secured to a rear surface adjacent a lower portion of said upward acting door, said backing plate including a axle secured thereto, said axle defining an axis, said axis having a hub rotatably supported thereabout, said latch means mounted to rotate about said axis, said sliding bolt lock secured to said backing plate adjacent to said distal end portion of said handle means when said handle means is in said latched position;
wherein said sliding bolt engages said latch means to prevent rotational movement of said latch means about said axis in a locked position and wherein said sliding bolt disengages said latch means in an unlocked position to allowed said latch means to pivot about said axis.

11. The latch and lock kit as described in claim 10 wherein said backing plate is constructed of steel.

12. The latch and lock kit as described in claim 10 wherein said backing plate is constructed of aluminum.

13. The latch and lock kit as described in claim 1 including a catch pin mounted to said door frame and engageable by said latch means for positively preventing upward movement of said door when said latch means is in said latched position.

14. The latch and lock kit as described in claim 10 wherein said catch pin is recessed into said door frame.

15. The latch and lock kit as described in claim 1 wherein said sliding bolt lock includes a multi-element pin assembly.

16. The latch and lock kit as described in claim 1 wherein said sliding bolt lock includes at least one electric circuit, wherein said at least one electric circuit is constructed and arranged to cooperate with at least one electric circuit in a lock key.

17. The latch and lock kit as described in claim 1 wherein said sliding bolt lock includes an ownership identification card, wherein said ownership identification card includes digital information required to make a key for said sliding bolt lock.

18. The latch and lock kit as described in claim 1 wherein said sliding bolt lock includes an ownership identification card, wherein said ownership identification card includes digital information required to open said sliding bolt lock.

19. A method of modifying an upward acting cargo container latch mechanism to include a sliding bolt lock, wherein said cargo container includes a bed portion, a left side wall, a right side wall, a front wall, a roof panel and an upward acting door, said upward acting door comprised of a plurality of horizontally hinged sections which are disposed in a substantially vertical plane, when said door is closed, and in a substantially horizontal plane near said roof panel when said door is open, said upward acting cargo container door including a latch means pivotally mounted upon a lower portion of said upwardly acting door, said latch means including a backing plate secured to a rear surface adjacent a lower portion of said door, said backing plate including a axle secured thereto, a hub rotatably supported on said axle, an elongated handle and a arcuate catch secured to said hub, said handle extending substantially radially from said hub, said handle having a distal end, said distal end of said handle including an integrally formed depending tab having an aperture drilled generally parallel to said handle, said arcuate catch extending from said hub and adapted to cooperate with a catch pin mounted to said bed portion of said cargo container, said latch means rotatable between a latched position and an unlatched position, said latch means including a latched keeper, wherein said latched keeper includes an integral hub pivotally mounted on pivot pin secured to said backing plate, said latched keeper having a downwardly and frontwardly projecting flange integrally formed on said hub, said flange having an opening which aligns with said aperture in said depending tab of said handle when the latch means is in said latched position, for receiving a conventional U-shaped shackle lock, wherein said steps for modifying said latch means to include a sliding bolt lock comprise:
removing said latched keeper from said backing plate;
positioning a sliding bolt lock adjacent to said distal end of said handle when said handle is in a latched position so that a sliding bolt portion of said sliding bolt lock engages said handle to prevent rotation thereof in a locked position;
securing said sliding bolt lock to said lower.portion of said door.

20. The method of modifying an upward acting cargo container latch mechanism to include a sliding bolt lock of claim 19, wherein said sliding bolt lock includes a body portion and a sliding bolt member, said sliding bolt member movable between a locked position and an unlocked position, whereby said sliding bolt member may be moved between said locked and said unlocked positions to engage and disengage respectively said aperture in said depending tab when said handle means is in said latched position for positively preventing movement or allowing movement respectively of said handle.

21. The method of modifying an upward acting cargo container latch mechanism to include a sliding bolt lock of claim 19, wherein said body portion of said sliding bolt lock includes a plurality of L-shaped tabs secured thereto, said L-shaped tabs constructed and arranged for attachment to said lower portion of said upwardly acting door, wherein each of said plurality of said L-shaped tabs include a vertical portion and a horizontal portion, wherein said vertical portion is secured to said body portion of said sliding bolt lock and wherein said horizontal portion includes at least one aperture therethrough for attachment to said lower portion of said upwardly acting door.

22. The method of modifying an upward acting cargo container latch mechanism to include a sliding bolt lock of claim 19, wherein said sliding bolt lock includes a lock casing for releasably securing said sliding bolt lock adjacent to said end portion of said handle said lock casing including an inner surface and an outer surface, said inner surface having a conjugate shape to said body portion of said sliding bolt lock, said outer surface including a plurality of L-shaped tabs secured thereto, wherein each of said plurality of said L-shaped tabs include a vertical portion and a horizontal portion, wherein said vertical portion is secured to said outer surface of said casing and wherein said horizontal portion includes at least one aperture therethrough.

23. The method of modifying an upward acting cargo container latch mechanism to include a sliding bolt lock of claim 22, wherein said lock casing and said L-shaped tabs are constructed of metal.
